(19) United States
(12) Patent Application Publication
(10) Pub. No.: US 2004/0245793 A1
(43) Pub. Date: Dec. 9, 2004

(54) Load space cover driven by electric motor

(76) Inventor: Klaus Fischer, Schopfloch (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/483,330

(22) PCT Filed: Jun. 19, 2002
(86) PCT No.: PCT/EP02/06793

(30) Foreign Application Priority Data
Jul. 13, 2001 (DE) 101 34 085.0

(51) Int. Cl. B60N 3/00

(52) U.S. Cl. 296/24.4

(57) ABSTRACT

An arrangement for covering purposes in the interior of a motor vehicle, having a web-like, displaceable covering at least one guide rail on which the covering element is guided, and at least one drive motor for displacing the covering element The drive motor is arranged directly on a transverse rod at an end of the covering element, and is displaced therewith.

This application claims the priority of German patent document 101340085.0, filed Jul. 13, 2001 (PCT/EP02/06793, filed Jun. 19, 2002), the disclosure of which is expressly incorporated by reference herein.

### BACKGROUND AND SUMMARY OF THE INVENTION

The invention relates to an arrangement for covering purposes in the interior of a motor vehicle, having a displaceable covering element, having at least one guide device on which the covering element can be guided, and having at least one drive motor.

Covering arrangements are used in motor vehicles, and in particular—but not exclusively—in station wagons, inter alia for covering the loading space in relation to the passenger compartment in order to prevent objects, for example, from flying about in the case of pronounced negative accelerations. A further use of such covering arrangements may be as roller blinds, as are used for blacking out windows of a motor vehicle.

Such an arrangement is presented, for example, in DE 19825353 A1. In this case, a web-like loading space cover is secured, on both sides, on carry-along elements which, for their part, are secured in each case on a toothed belt which is guided over deflecting rollers. The two toothed belts are each driven by an electric motor and a gear mechanism which acts on the deflecting rollers. The disadvantage with this embodiment, on the one hand, is the high design outlay and, on the other hand, the large amount of space required, since it is precisely in automotive engineering that the amount of installation space constitutes a highly limiting factor.

The object on which the invention is based is to develop a covering arrangement which is intended for the interior of the motor vehicle and, with a simultaneously high level of functional reliability, requires only a small amount of installation space.

In order to achieve this object, it is proposed according to the invention, in the case of a covering arrangement of the generic type, that the drive motor is arranged on the covering element and can be displaced therewith.

The drive motor may thus be accommodated directly in the loading space, where the amount of space available is generally greatest. By virtue of the drive motor being arranged on the covering element, it is also possible for the supply lines from the motor to the necessary drive device for displacing the covering element to be realized with correspondingly low outlay and short distances.

In an advantageous development, the covering element, at its end-side termination, has a transverse rod which is arranged largely parallel to the termination and of which the at least one end engages with the guide device.

The end-side termination here is the side of the web-like covering element which is located orthogonally in relation to the movement direction. The transverse rod, which is arranged on this termination likewise orthogonally in relation to the movement direction, stabilizes this free end of the web and, on account of its rigidity and of it interacting with the guide device, guarantees that the covering element is guided reliably during displacement.

Furthermore, it is favorable for the drive motor to be arranged in the region of the transverse rod. On account of its higher level of rigidity in comparison with the web-like covering element, the transverse rod is particularly suitable for the arrangement of the drive motor. It is also favorable in the case of this arrangement if the transverse rod and thus also the drive motor are located in the vicinity of the guide device.

In an expedient configuration, the transverse rod comprises two aligned sub-rods, between which the motor is arranged, with the result that the motor can be integrated in the transverse rod and installed in as space-saving a manner as possible.

The drive motor is advantageously assigned at least one planet gear mechanism, a drive shaft being arranged such that it runs at least in one of the transverse sub-rods and engages through the latter in the longitudinal direction. This type of gear mechanism makes it possible to adapt the drive, in respect of the amount of space required, to the shape of the transverse rod, in order that the gear mechanism can be integrated as far as possible in the rod. Furthermore, the drive shaft is protected against external influences by being arranged in the transverse sub-rod.

An expedient development here is for a gearwheel to be arranged on the output side, on the end side of the at least one drive shaft, and to engage with a correspondingly designed toothed profile of the guide device. This is the logically consistent continuation of the gear-mechanism design adapted to the shape of the rod, and results in a minimal spacing between the drive motor and the displacement device, based on the interaction of the two toothed profiles. Furthermore, the amount of space required is also correspondingly small.

It is further expedient if the drive motor is integrated in the centre of the transverse rod and, on both sides, has a planet gear mechanism with a drive shaft and a gearwheel arranged in each case on the end side of the latter. In this case, the respective gearwheel engages with the corresponding toothed profile in each case of one of the guide devices. Guidance on both sides and propulsion on both sides results in the displacement of the covering element being more uniform and less susceptible to malfunctioning.

The drive motor advantageously has a casing designed as a handle. This handle on the transverse rod allows the band-like covering element to be moved by central action and, without any additional outlay for a further handle, also by hand, it being expedient to provide a corresponding through-passage opening in the covering element in the region of the drive motor, in order to allow the handle to be gripped reliably. The casing here also expediently encloses the at least one planet gear mechanism, which is arranged on the drive motor.

It is also favorable for the drive motor to be designed as an electric motor, and in an expedient development at least one guide device has a busbar, and a current collector which interacts with the busbar is arranged in the region of the end side of the transverse rod.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic illustration, in detail form, of a loading space cover of a passenger vehicle, and

FIG. 2 shows a guide rail of the loading space cover in cross section.

### DETAILED DESCRIPTION OF THE DRAWINGS

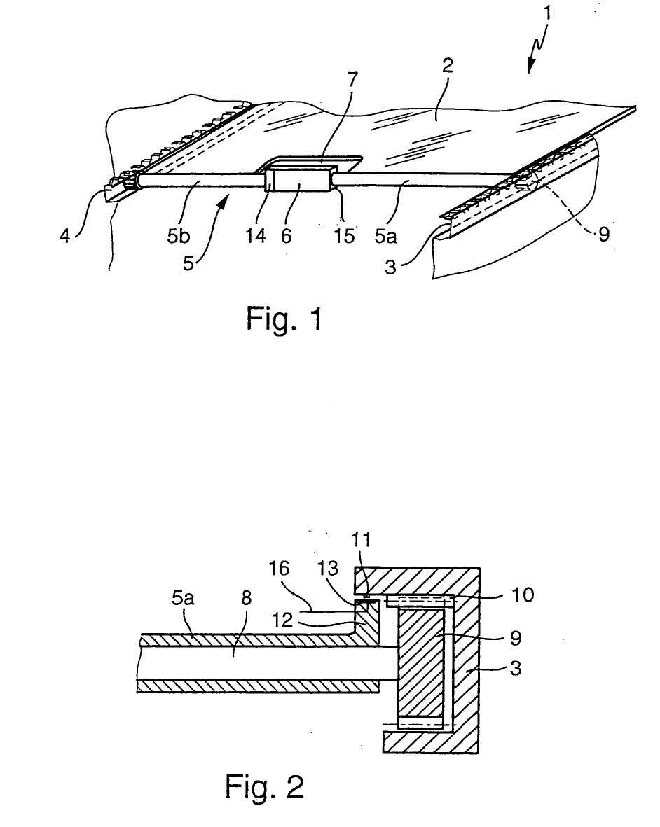

FIG. 1 shows a schematic illustration of an arrangement 1 for covering a loading space of a passenger vehicle, the intention being for this arrangement to prevent the situation, for example, where objects which are located in the loading space penetrate into the passenger compartment in the case of a high level of negative acceleration in the event of pronounced braking or of an accident. The cover itself comprises a web-like covering element 2, preferably made of a firm but nevertheless flexible material such as leather or imitation leather. The covering element 2 can be moved in a stepless manner between different positions. The movement of the covering element here takes place along a track which is predetermined by guide devices 3 and 4, the guide devices being guide rails which run in the movement direction parallel to both sides of the covering element 2. The free, end-side termination of the covering element 2 is formed by a rigid transverse rod 5. This transverse rod 5 stiffens the inherently flexible covering element 2 at its end-side termination. The two ends of the transverse rod 5 engage in the guide rails 3 and 4 and are guided in a movable manner therein. The central component of the transverse rod 5 is formed by a drive motor 6 which is configured as an electric motor, is aligned with the transverse rod 5 and by means of which the covering element—as is illustrated in detail hereinbelow—can be moved along the guide rails. Arranged on both end sides of the motor 6 and in alignment therewith, and also with the adjoining transverse rod 5, are planet gear mechanisms 14 and 15, which are driven by the drive motor 6. In the exemplary embodiment illustrated, the transverse rod 5 comprises two individual, aligned sub-rods 5a and 5b extending on both sides of the drive motor, the planet gear mechanism 14, 15 being arranged in each case between the sub-rods 5a and 5b and the motor.

The drive motor 6 is formed externally here as a type of handle, with the result that the passenger-vehicle user can also move the covering element 2 by gripping the motor, i.e. the handle, by hand and pushing or pulling the covering element 2 in the desired direction along the guide rails 3 and 4. For this purpose, however, the propulsion, which is illustrated hereinbelow, by means of the drive motor has to be triggered. It is also possible for the guide rails to be provided with recesses, via which the transverse rod and the covering element can be lifted out of the guide and also reinserted.

In the region of the drive motor 6, the covering element has a cutout 7, which makes it easier to grip the drive motor and thus use the latter as a handle.

FIG. 2 shows the guide rail 3 from FIG. 1 in cross section. Engaging with this guide rail 3 is a drive shaft 8, which is driven by the drive motor 6 (FIG. 1) via a planet gear mechanism 15 (FIG. 1). The guide rail 3 here is of U-shaped design, the drive shaft 8 engaging in the open side of the rail, which is oriented in the direction of the drive motor. The drive shaft 8 here is arranged in the interior of the transverse sub-rod 5a, which is designed with an annular cross section, the drive rod engaging through the transverse sub-rod 5a and passing out of the latter, by way of its output-side end side, in the region of the guide rail 3. Arranged in a rotationally fixed manner on this output-side end side of the drive shaft 8 is a gearwheel 9, which is moved via the drive shaft 8. The gearwheel 9 has its profile engaging with a toothed profile 10 which is formed throughout the possible displacement region of the covering element where the latter is guided along the guide rail 3. The interengagement of the gearwheel 9 and of the toothed profile 10 also prevents the gearwheel 9 and, via the motor 6, also the covering element 2 from moving in an undesirable manner of their own accord. The guide rail 4, which is not illustrated in this figure, is designed in a mirror-symmetrical manner in relation to the guide rail 3 shown.

On the inside of the top leg of the U shape, but outside the region in which the toothed profile 10 is formed, the guide rail 3 additionally has a busbar 11, which runs parallel to the guide rail 3. A radial extension 12 with a current collector 13 is located on the outside of the transverse rod 5a in this region, the current collector 13 forming a sliding contact with the busbar 11 at all times. From the current collector 13, a cable leads along the transverse rod 5a to the drive motor, which is illustrated in FIG. 1 and is supplied with electric current via said cable.

Recesses (not illustrated) are provided at various locations of the guide rails, and it is possible for the transverse rod to be lifted out of the guide rails, and reinserted, by hand in the region of said recesses. For this purpose, it is necessary for the gearwheel to be drawn out of the toothed profile perpendicularly to the displaced direction of the covering, and pushed into this profile again in the opposite direction, in order for it to be possible for the intermeshing teeth to be separated. The drive motor, designed as a handle, is particularly suitable for this handling operation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-11. (Cancel)

12. An arrangement for covering purposes in the interior of a motor vehicle, having a displaceable covering element, having at least one guide device on which the covering element can be guided, and having at least one drive motor, wherein the drive motor is arranged on the covering element and can be displaced therewith.

13. The arrangement as claimed in claim 12, wherein the covering element, at its end-side termination, has a transverse rod which is arranged largely parallel to the termination and of which the at least one end engages with the at least one guide device.

14. The arrangement as claimed in claim 13, wherein the drive motor is arranged in the region of the transverse rod.

15. The arrangement as claimed in claim 13, wherein the transverse rod comprises two aligned transverse sub-rods, between which the drive motor is arranged.

16. The arrangement as claimed in claim 14, wherein the transverse rod comprises two aligned transverse sub-rods, between which the drive motor is arranged.

17. The arrangement as claimed in claim 15, wherein the drive motor is assigned at least one planet gear mechanism, a drive shaft of the planet gear mechanism being arranged such that it runs at least in one of the transverse sub-rods and engages through the latter in the longitudinal direction.

18. The arrangement as claimed in claim 17, wherein a gearwheel is arranged on the output side, on the end side of the at least one drive shaft, and engages with a correspondingly designed toothed profile of the guide device.

19. The arrangement as claimed in claim 13, wherein the drive motor is integrated in the center of the transverse rod and, on both sides, has a planet gear mechanism with a drive shaft and in each case one gearwheel which is arranged on the end side of the latter and engages with in each case one of the guide device, arranged on both sides, with corresponding toothed profile.

20. The arrangement as claimed in claim 19, wherein the drive motor has a casing designed as a handle.

21. The arrangement as claimed in claim 20, wherein the at least one planet gear mechanism, which is arranged on the drive motor, is enclosed by the casing.

22. The arrangement as claimed in claim 20, wherein the covering element has a through-passage opening in the region of the drive motor.

23. The arrangement as claimed in claim 21, wherein the covering element has a through-passage opening in the region of the drive motor.

24. The arrangement as claimed in claim 13, wherein the drive motor is an electric motor and at least one guide device has a busbar, a current collector which interacts with the busbar being arranged in the region of the end side of the transverse rod.

25. The arrangement as claimed in claim 19, wherein the drive motor is an electric motor and at least one guide device has a busbar, a current collector which interacts with the busbar being arranged in the region of the end side of the transverse rod.

26. An apparatus for covering at least a portion of a vehicle interior, comprising:
a displaceable covering element;
at least one guide device located in the vehicle interior arranged to guide displacement of the covering element; and
at least one drive motor arranged on the covering element to displace the covering element, wherein the at least one drive motor is displaced with the covering element when the covering element is displaced.

27. The apparatus of claim 26, further comprising:
a transverse rod arranged at, and essentially parallel, to a covering element end termination,
wherein at least one end of the transverse rod engages at least one engagement surface of the at least one guide device.

28. The apparatus of claim 27, wherein the drive motor is located on or adjacent to the transverse rod.

29. The apparatus of claim 27, wherein the transverse rod comprises two transverse sub-rods extending in opposite directions from the drive motor.

30. The arrangement as claimed in claim 28, wherein the transverse rod comprises two aligned transverse sub-rods extending in opposite directions from the drive motor.

31. The apparatus of claim 29, further comprising:
at least one planet gear mechanism driven by the drive motor, wherein a drive shaft of the planet gear mechanism rotates one of a shaft running longitudinally through at least one of the transverse sub-rods and one of the transverse sub-rods.

32. The apparatus of claim 31, further comprising
a gearwheel, wherein the gearwheel engages a correspondingly toothed profile of the guide device and is rotated by the drive shaft.

33. The apparatus of claim 27, wherein the drive motor is located at a center of the transverse rod, further comprising:
a planet gear mechanism at each of two opposite ends of the drive motor,
wherein each planet gear mechanism is driven by the drive motor and has a drive shaft arranged to rotate a gearwheel at an outer end of the transverse rod, each gearwheel engaging a corresponding toothed profile of one of the at least one guide device.

34. The apparatus of claim 33, wherein the drive motor has a casing designed as a handle.

35. The apparatus of claim 34, wherein the planet gear mechanisms, are enclosed by the casing.

36. The apparatus of claim 34, wherein the covering element has an opening adjacent to the drive motor.

37. The apparatus of claim 27, wherein the drive motor is an electric motor and at least one guide device has a busbar which interacts with a busbar on the transverse rod to conduct electrical energy to the drive motor.

38. The apparatus of claim 33, wherein the drive motor is an electric motor and at least one guide device has a busbar which interacts with a busbar on the transverse rod to conduct electrical energy to the drive motor.

39. A cover for covering at least a portion of a vehicle interior, comprising:
a covering element;
at least one drive motor arranged on the covering element; and
a transverse rod arranged at, and essentially parallel, to a covering element end termination,
wherein the drive motor is located on or adjacent to the transverse rod.

40. The cover of claim 39, wherein the drive motor is located at a center of the transverse rod, further comprising:
a planet gear mechanism at each of two opposite ends of the drive motor,
wherein each planet gear mechanism is driven by the drive motor and has a drive shaft arranged to rotate a gearwheel at an outer end of the transverse rod.

41. The apparatus of claim 40, wherein the drive motor has a casing designed as a handle.

42. A method for covering at least one portion of a vehicle interior, comprising the steps of:
providing a motor-driven a covering element, the cover element including:
at least one drive motor arranged on the covering element;
a transverse rod arranged at, and essentially parallel, to a covering element end termination, wherein the drive motor is located on or adjacent to the transverse rod; and
a planet gear mechanism at each of two opposite ends of the drive motor, wherein each planet gear mechanism is driven by the drive motor and has a drive shaft arranged to rotate a gearwheel at an outer end of the transverse rod;
engaging at least one gearwheel with an engagement surface of a guide device; and
causing the drive motor to rotate the at least one gearwheel to draw the covering element along the guide device to cover the at least one portion of the vehicle interior.
